(19) United States
(12) Patent Application Publication
(10) Pub. No.: US 2011/0186237 A1
(43) Pub. Date: Aug. 4, 2011

(54) WEB PRODUCT EMBOSSING APPARATUS

(76) Inventor: Wei-Shuai LIN, Taoyuan (TW)

(21) Appl. No.: 12/874,524

(22) Filed: Sep. 2, 2010

(30) Foreign Application Priority Data
Jan. 29, 2010 (TW) 099102544
Apr. 14, 2010 (CN) 201010151632.X

(51) Int. Cl. B32B 38/06

(52) U.S. Cl. 156/549

(57) ABSTRACT

A web product embossing apparatus includes a first embossing wheel set formed of multiple embossing wheels and adapted for embossing a raised first embossed pattern on a first web product, a second embossing wheel set adapted for embossing a raised second embossed pattern on a second web product, and a plurality of glue applicators disposed adjacent to the first embossing wheel set and adapted for applying different glues having different colors to different pattern units of the raised first embossed pattern for enabling the first web product and the second web product to be bonded together to form an embossed colorful finished web product.

### BACKGROUND OF THE INVENTION

1. Technical Field

The present invention relates to a web product embossing apparatus adapted for embossing colorful embossed patterns on a web product.

2. Description of the Prior Art

FIG. 1 illustrates a conventional web product embossing apparatus. As illustrated, the web product embossing apparatus 10 comprises an embossing wheel set 11, a first transferring wheel 13, a second transferring wheel 14, a glue applicator 15 and a roller 17. The embossing wheel set 11 comprises a plurality of raised embossing portions for embossing multiple embossed patterns on a first web product 121. The first transferring wheel 13 and the second transferring wheel 14 are adapted for transferring the first web product 121 and a second web product 123.

The glue applicator 15 is adapted to contact the first web product 121 at the roller 17 and to apply a glue 16 to the first web product 121 for enabling the first web product 121 and the second web product 123 to be bonded together by the glue 16.

The first web product 121 is being transferred through the embossing wheel set 11, the raised embossing portions of the embossing wheel set 11 are forced against the first web product 121, forming multiple raised embossed patterns on the first web product 121. Because the raised embossed patterns of the first web product 121 protrude outwards, the glue applicator 15 applies the glue 16 to the raised embossed patterns of the first web product 121 when the first web product 121 is being transferred through the gap in between the glue applicator 15 and the flat surface of the roller 17.

After application of the glue 16, the first web product 121 and the second web product 123 are bonded together to form a finished web product 12. Further, in actual practice, the glue contains a color pigment so that the embossed pattern embossed on the first web product 121 can have a single color and the finished web product 12 can provide a rich visual sensation.

### SUMMARY OF THE PRESENT INVENTION

It is, therefore, the main object of the present invention to provide a web product embossing apparatus, which uses multiple glue applicators to apply different glues containing different color pigments to different areas of the embossed pattern for showing a color sense of beauty.

It is another object of the present invention to provide a web product embossing apparatus, wherein each glue applicator wheel has at least one glue applicator portion raised from the periphery thereof such that the glue is constrained to the area of the at least one glue applicator portion for application to a specific area at the embossed pattern for enabling the embossed pattern to have multiple colors.

It is still another object of the present invention to provide a web product embossing apparatus, wherein the first embossing wheel set is kept in contact with multiple glue applicators, and the size of the glue applicator portion of each glue applicator is adjustable so that the glue applicators can apply different glues containing different color pigments to different areas of the embossed pattern.

It is still another object of the present invention to provide a web product embossing apparatus, wherein the embossed pattern is divided into multiple pattern units; the glue applicators are adapted for applying different glues containing different color pigments to different pattern units of the embossed pattern so that the single embossed pattern can have different colors.

It is still another object of the present invention to provide a web product embossing apparatus, which is adapted for embossing different embossed patterns on multiple web products, and then bonding the embossed web products with a glue or multiple glues to form a soft and bulky finished web product.

It is still another object of the present invention to provide a web product embossing apparatus, which enables three layers or more than three layers of web products to be bonded together to form a soft and bulky finished web product in which the intermediate layer of web product can be prepared from a relatively inferior material to reduce the cost without affecting the product quality.

To achieve these and other objects of the present invention, a web product embossing apparatus comprises a first embossing wheel set, a transferring wheel set, a first glue applicator and a second glue applicator. The first embossing wheel set comprises a first embossing wheel and a second embossing wheel. The second embossing wheel comprises a plurality of protrusions raised from the periphery thereof and adapted for embossing at least one raised first embossed pattern on a first web product. The raised first embossed pattern comprises a first pattern unit and a second pattern unit. The transferring wheel set is adapted for transferring a second web product to the first embossing wheel set. The first glue applicator is disposed adjacent to the first embossing wheel set, and adapted for applying a first glue to the first pattern unit. The first glue contains a first color pigment. The second glue applicator is disposed adjacent to the first embossing wheel set, and adapted for applying a second glue to the second pattern unit. The second glue contains a second pigment. The second pigment has a different color relative to the first color pigment.

To achieve these and other objects of the present invention, a web product embossing apparatus comprises a first embossing wheel set, a transferring wheel set and a plurality of glue applicators. The first embossing wheel set comprises a first embossing wheel and a second embossing wheel. The second embossing wheel comprises a plurality of protrusions raised from the periphery thereof and adapted for embossing at least one raised first embossed pattern on a first web product. Each raised first embossed pattern comprises a plurality of pattern units. The transferring wheel set is adapted for transferring a second web product to the first embossing wheel set. The glue applicators are disposed adjacent to the first embossing wheel set and adapted for applying different glues having different colors to different pattern units of each raised first embossed pattern.

### BRIEF DESCRIPTION OF THE DRAWINGS

FIG. 1 is a schematic structural view of a web product embossing apparatus, according to the prior art.

FIG. 2 is a schematic structural view of a web product embossing apparatus, in accordance with a first embodiment of the present invention.

FIGS. 2A-2D are enlarged view of different parts of the web product embossing apparatus in accordance with the first embodiment of the present invention.

FIGS. 3A and 3B are schematic sectional views of finished web products made according to the first embodiment of the present invention.

FIG. 4 is a schematic structural view of a web product embossing apparatus, in accordance with a second embodiment of the present invention.

FIGS. 5A and 5B are schematic sectional views of finished web products made according to the second embodiment of the present invention.

FIG. 6 is a schematic structural view of a web product embossing apparatus, in accordance with a third embodiment of the present invention.

FIGS. 7A and 7B are schematic sectional views of finished web products made according to the third embodiment of the present invention.

FIG. 8 is a schematic structural view of a web product embossing apparatus, in accordance with a fourth embodiment of the present invention.

FIG. 9 is a schematic structural view of a web product embossing apparatus, in accordance with a fifth embodiment of the present invention.

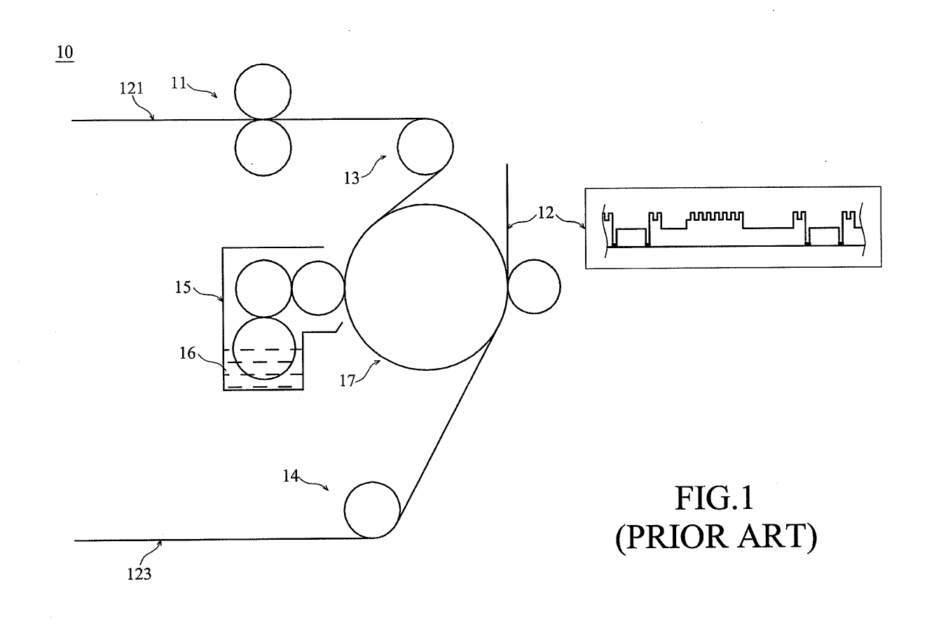

### DETAILED DESCRIPTION OF THE PREFERRED EMBODIMENTS

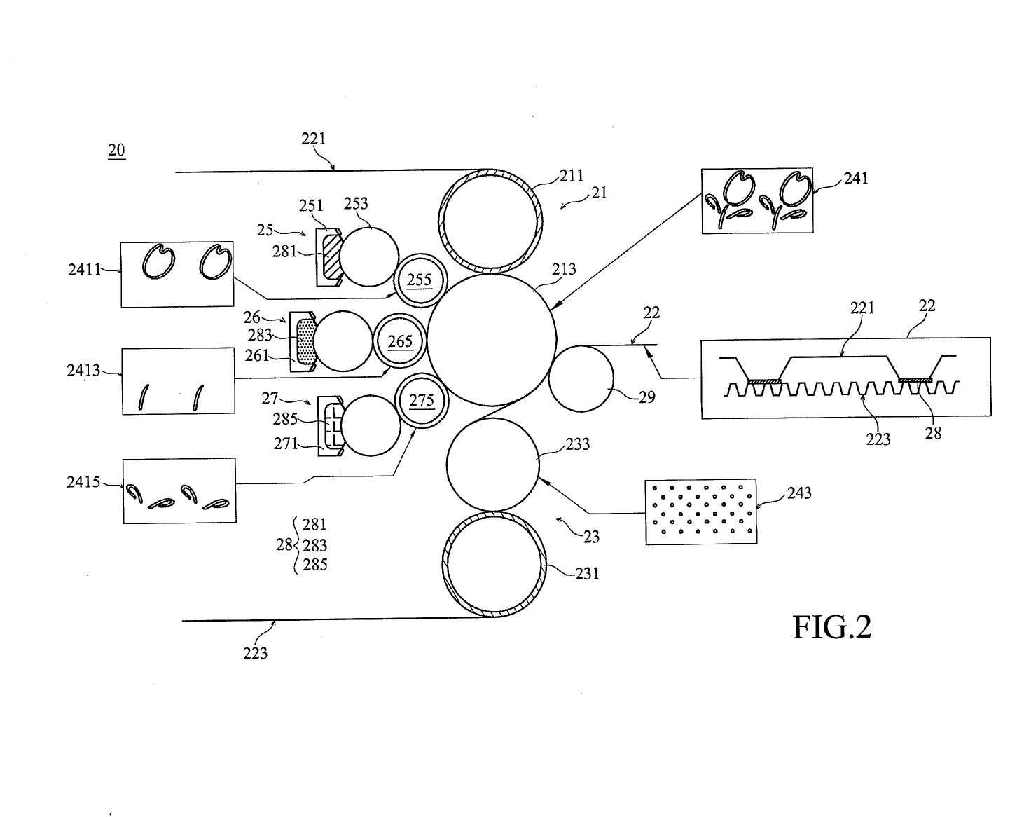

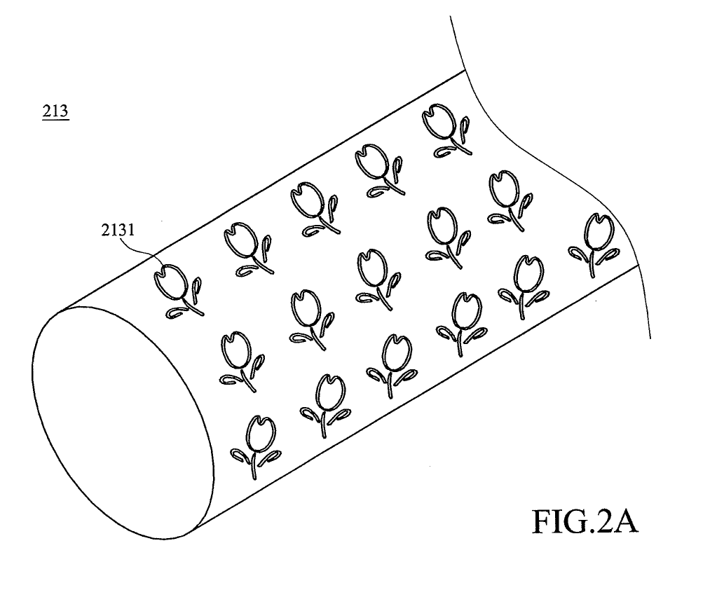

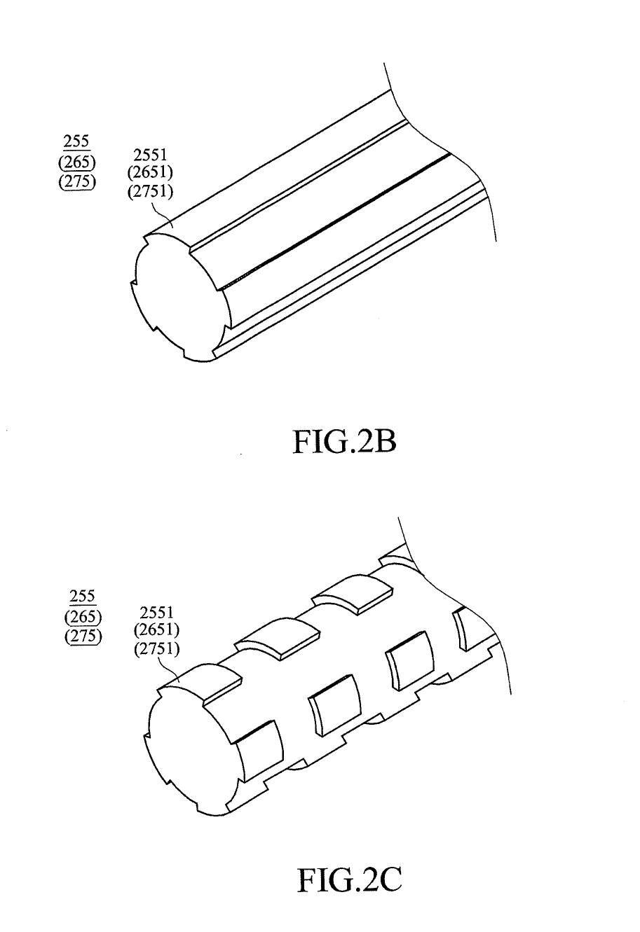

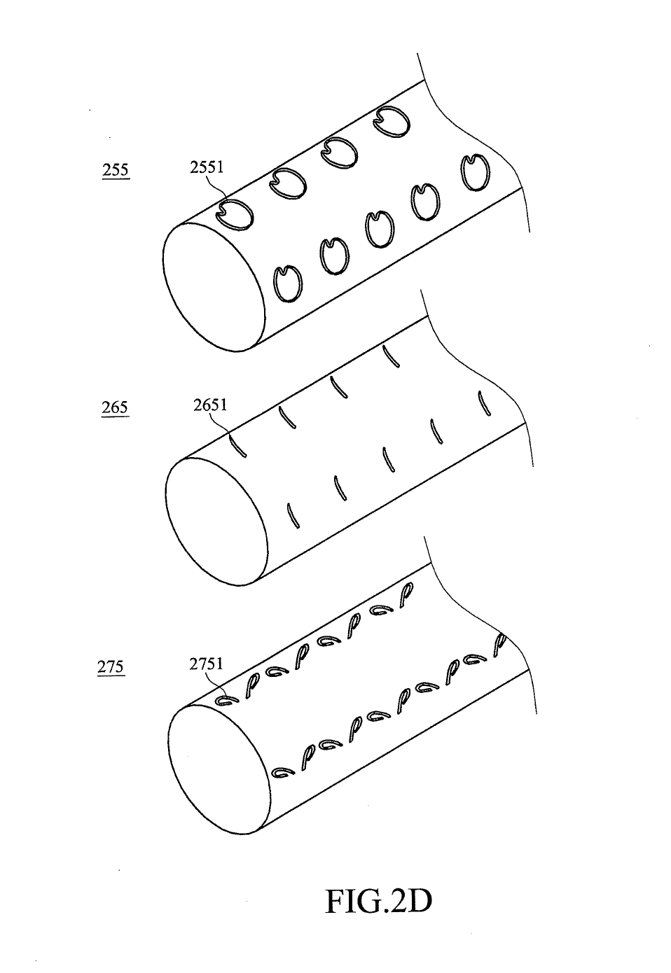

Please refer to FIG. 2, a web product embossing apparatus 20 in accordance with a first embodiment of the present invention is shown. The web product embossing apparatus 20 comprises a first embossing wheel set 21, a second embossing wheel set 23 and a plurality of glue applicators 25/26/27. The glue applicators 25/26/27 are arranged adjacent to the first embossing wheel set 21 and adapted for applying a glue to a first web product 221. The number of the glue applicators can be 2 or more than 2. According to this embodiment, 3 glue applicators are used.

The first embossing wheel set 21 is adapted for transferring the first web product 221 and embossing a first embossed pattern 241 on the first web product 221. According to this embodiment, the first embossing wheel set 21 comprises a first embossing wheel 211 and a second embossing wheel 213. The first embossing wheel 211 and the second embossing wheel 213 are respectively rotatably abutted against each other for transferring the first web product 221 therebetween. When the first embossing wheel 211 and the second embossing wheel 213 are rotated, they transfer the first web product 221 forwards, forming a raised first embossed pattern 241 on the first web product 221.

The first embossing wheel 211 is prepared from an elastically deformable material. The second embossing wheel 213 is prepared from a non-deformable material. According to this embodiment, the first embossing wheel 211 is a rubber wheel; the second embossing wheel 213 is a steel wheel having protrusions 2131 raised from the periphery thereof and configured subject to the designed first embossed pattern 241. Upon contact between the second embossing wheel 213 and the first embossing wheel 211, the first embossing wheel 211 is forced to deform by the protrusions 2131 of the second embossing wheel 213, allowing the protrusions 2131 of the second embossing wheel 213 to sink into the periphery of the first embossing wheel 211, and therefore a first embossed pattern 241 is embossed on the first web product 221, as shown in FIG. 2A.

The second embossing wheel set 23 is adapted for transferring a second web product 223 and embossing at least one second embossed pattern 243 on the second web product 223 and then transferring the embossed second web product 223 to the first embossing wheel set 21. According to this embodiment, the second embossing wheel set 23 comprises a third embossing wheel 231 and a fourth embossing wheel 233. The third embossing wheel 231 and the fourth embossing wheel 233 are respectively rotatably abutted against each other to transfer the second web product 223 therebetween. When the third embossing wheel 231 and the fourth embossing wheel 233 are rotated, they transfer the second web product 233 forwards, forming a raised second embossed pattern 243 on the second web product 233.

The third embossing wheel 231 is prepared from a deformable material. The fourth embossing wheel 233 is prepared from a non-deformable material. According to this embodiment, the third embossing wheel 231 is a rubber wheel; the fourth embossing wheel 233 is a steel wheel having protrusions (not shown) raised from the periphery thereof and configured subject to the designed second embossed pattern 243.

According to this embodiment, the glue applicators 25/26/27 of the web product embossing apparatus 20 include a first glue applicator 25, a second glue applicator 26 and a third glue applicator 27. The first glue applicator 25, the second glue applicator 26 and the third glue applicator 27 are arranged adjacent to the first embossing wheel set 21 and adapted for applying a glue 28 to the first web product 221.

The first glue applicator 25 comprises a first glue reservoir 251, a first roller 253 and a first glue applicator wheel 255. The first glue reservoir 251 holds a first glue 281. The first roller 253 is abutted against the first glue reservoir 251, and rotatable to transfer the first glue 281 from the first glue reservoir 251 to the first glue applicator wheel 255. The first glue applicator wheel 255 is kept in contact with the first web product 221 at the first embossing wheel set 21 for applying the first glue 281 to the first web product 221. Further, when rotating the first roller 253 to transfer the first glue 281 from the first glue reservoir 251 to the first glue applicator wheel 255, the first roller 253 also mix the first glue 281 in the first glue reservoir 251. For example, the first glue 281 can contain a first pigment. During rotation of the first roller 253, the first pigment is well mixed in the first glue 281, making a color to the first glue 281.

The first glue applicator wheel 255 has at least one, for example, a plurality of first glue applicator portions 2551 raised from the periphery thereof. The first glue applicator portions 2551 can be shaped like a long bar or configured subject to any of a variety of geometric shapes. Thus, the first roller 253 transfers the first glue 281 from the first glue reservoir 251 to the first glue applicator portions 2551 of the first glue applicator wheel 255 for application, as shown in FIG. 2B and FIG. 2C. Further, when the first glue applicator wheel 255 is applying the first glue 281 to the first web product 221, only the first glue applicator portions 2551 will contact the first embossed pattern 241 at the first web product 221 and apply the first glue 281 to part of the first embossed pattern 241 at the first web product 221.

The second glue applicator 26 and the third glue applicator 27 are substantially similar to the first glue applicator 25 in structure. Further, the second glue applicator wheel 265 of the second glue applicator 26 has at least one, for example, a plurality of second glue applicator portions 2651 raised from the periphery thereof, and the third glue applicator wheel 275 of the third glue applicator 27 has at least one, for example, a plurality of second glue applicator portions 2751 raised from the periphery thereof, as shown in FIG. 2B and FIG. 2C. Further, the second glue reservoir 261 of the second glue applicator 26 holds a second glue 283 that has contained therein a second pigment; the third glue reservoir 271 of the third glue applicator 27 holds a third glue 285 that has contained therein a third pigment. The first pigment, the second pigment and the third pigment have different colors so that the first glue 281, the second glue 283 and the third glue 285 show different colors.

Because the second embossing wheel 213 has a plurality of protrusions 2131 raised from the periphery thereof for embossing a raised first embossed pattern 241 on the first web product 221, the applied glue 28 is retained at the raised first embossed pattern 241 on the first fiver sheet product 221. Further, the glue applicators 25/26/27 can be controlled to apply the respective glues 281/283/285 to different block areas at the raised first embossed pattern 241.

In actual practice, the first, second and third glue applicator portions 2551/2651/2751 of the first, second and third glue applicator wheel 255/265/275 are arranged at different locations corresponding to different block areas of the raised first embossed pattern 241 on the first web product 221 so that the raised first embossed pattern 241 on the first web product 221 show different colors after having been glued. According to this embodiment, the raised first embossed pattern 241 is formed of multiple pattern units. For example, the raised first embossed pattern 241 can be made comprising a first pattern unit 2411, a second pattern unit 2413 and a third pattern unit 2415. During gluing, the first glue applicator portions 2551 of the first glue applicator wheel 255 will be moved into contact with the first pattern unit 2411 to apply the first glue 281 containing the first pigment to the first pattern unit 2411; the second glue applicator portions 2651 of the second glue applicator wheel 265 will be moved into contact with the second pattern unit 2413 to apply the second glue 283 containing the second pigment to the second pattern unit 2413; the third glue applicator portions 2751 of the third glue applicator wheel 275 will be moved into contact with the third pattern unit 2415 to apply the third glue 285 containing the third pigment to the third pattern unit 2415. Thus, the first pattern unit 2411, second pattern unit 2413 and third pattern unit 2415 of the first pattern unit 2411 will show different colors. For example, if the first glue 281, the second glue 283 and the third glue 285 are prepared in red color, light green color and dark green color respectively, the first pattern unit 2411, the second pattern unit 2413 and the third pattern unit 2415 will show red color, light green color and dark green color respectively.

Further, as shown in FIG. 2D, the first glue applicator portions 2551 of the first glue applicator wheel 255 can be configured similar to the shape of the first pattern unit 2411; the second glue applicator portions 2651 of the second glue applicator wheel 265 can be configured similar to the shape of the second pattern unit 2413; the third glue applicator portions 2751 of the third glue applicator wheel 275 can be configured similar to the shape of the third pattern unit 2415.

The web product embossing apparatus 20 further comprising an impression unit 29 adapted for imparting a pressure to the first web product 221 against the second web product 223 so that the first web product 221 and the second web product 223 can be adhered together, forming a finished web product 22. The impression unit 29 can be, for example, an impression roller kept in proximity to the second embossing wheel 213 so that the first web product 221 and the second web product 223 can be fed through the gap in between the second embossing wheel 213 and the impression unit 29 and bonded together.

In one example of the present invention, the first web product 221 is a single-layer of paper processed to carry a raised first embossed pattern 241 (for example, a coarse pattern) in multiple colors and the second web product 223 is a single-layer of paper processed to carry a raised second embossed pattern 243 (for example, a fine pattern), and then the first web product 221 and the second web product 223 are bonded together by the glue 28, forming the desired finished web product 22 as shown in FIG. 2.

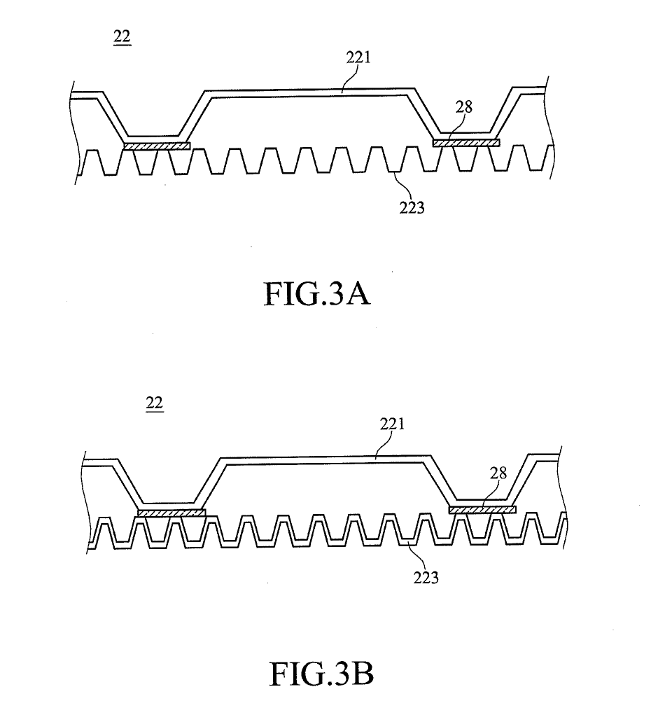

In another example of the present invention, the first web product 221 is a double-layer of paper and the second web product 223 is a single-layer of paper, and the finished web product 22 is as shown in FIG. 3A. In still another example of the present invention, the first web product 221 and the second web product 223 are double-layer of paper, and the finished web product 22 is as shown in FIG. 3B.

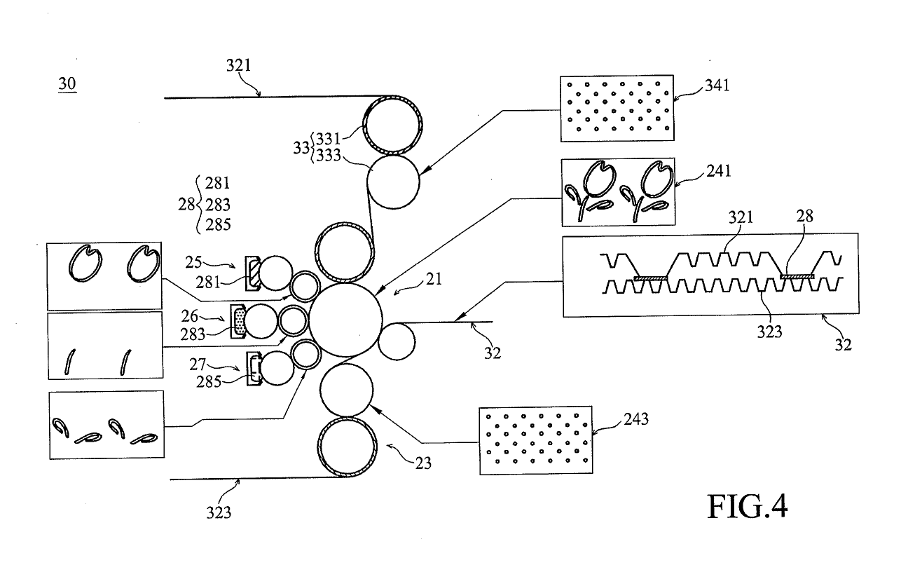

Referring to FIG. 4, a web product embossing apparatus 30 in accordance with a second embodiment of the present invention is shown. The web product embossing apparatus 30 comprises a first embossing wheel set 21, a second embossing wheel set 23, a third embossing wheel set 33 and a plurality of glue applicators 25/26/27. The glue applicators 25/26/27 are arranged adjacent to the first embossing wheel set 21 and adapted for applying a respective glue to a first web product 321 at the first embossing wheel set 21.

According to this embodiment, the third embossing wheel set 33 is operated to emboss a raised third embossed pattern 341 on the first web product 321 at first. The third embossing wheel set 33 comprises a fifth embossing wheel 331 and a sixth embossing wheel 333. The fifth embossing wheel 331 is made of an elastically deformable material. The sixth embossing wheel 333 is made of a non-deformable material. For example, the fifth embossing wheel 331 can be a rubber wheel. The sixth embossing wheel 333 is a steel wheel having protrusions (not shown) raised from the periphery thereof and adapted for embossing a raised third embossed pattern 341 on the first web product 321.

After formation of the raised third embossed pattern 341 on the first web product 321 by the third embossing wheel set 33, the first web product 321 is continuously transferred to the first embossing wheel set 21 where the first embossing wheel set 21 embosses a raised first embossed pattern 241 on the first web product 321. Thus, the first web product 321 can have the raised first embossed pattern 241 and the raised third embossed pattern 341.

Thereafter, the glue applicators 25/26/27 are operated to apply different glues 281/283/285 to the first web product 321 at the first embossing wheel set 21 so that the raised first embossed pattern 241 of the first web product 321 can have different colors, and then the first web product 321 is bonded with a second web product 323 to form a finished web product 32.

According to the aforesaid second embodiment, the first web product 321 carries the raised first embossed pattern 241 and the raised third embossed pattern 341, and the second web product 323 carries the raised second embossed pattern 243. Subject to the arrangement of the raised second embossed pattern 243 and the raised third embossed pattern 341, a big gap is left in between the first web product 321 and the second web product 323 so that the finished web product 32 can have bulky, soft and thick features.

Further, in one example of this second embodiment, the first web product 321 is a single-layer of paper processed to carry a colorful first embossed pattern 241 (for example, a coarse pattern) and a third embossed pattern 341 (for example, a fine pattern), and the second web product 323 is a single-layer of paper processed to carry a second embossed pattern 243 (for example, a fine pattern), and then the first web product 321 and the second web product 323 are bonded together by the glue 28, forming the desired finished web product 32 as shown in FIG. 4.

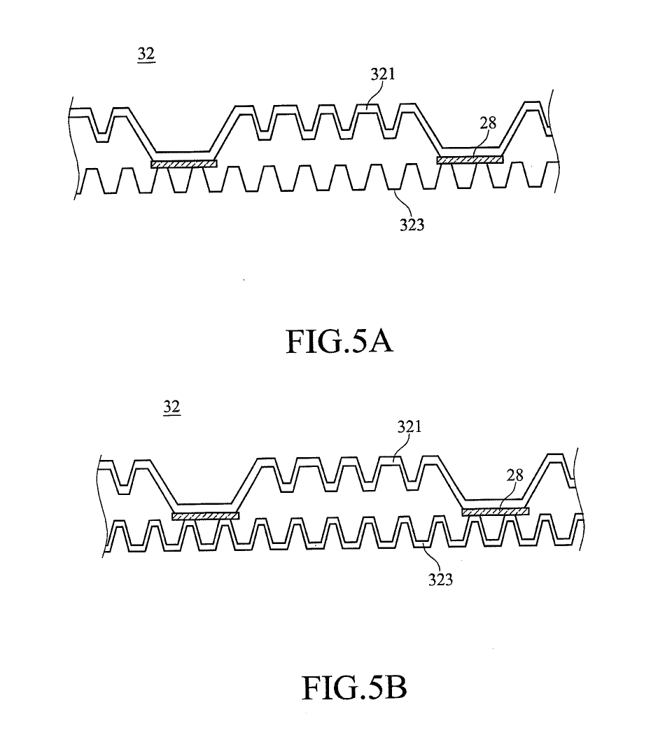

In another example of this second embodiment, the first web product 321 is a double-layer of paper and the second web product 323 is a single-layer of paper, and the finished web product 32 is as shown in FIG. 5A. In still another example of this second embodiment, the first web product 321 and the second web product 323 are double-layer of paper, and the finished web product 32 is as shown in FIG. 5B.

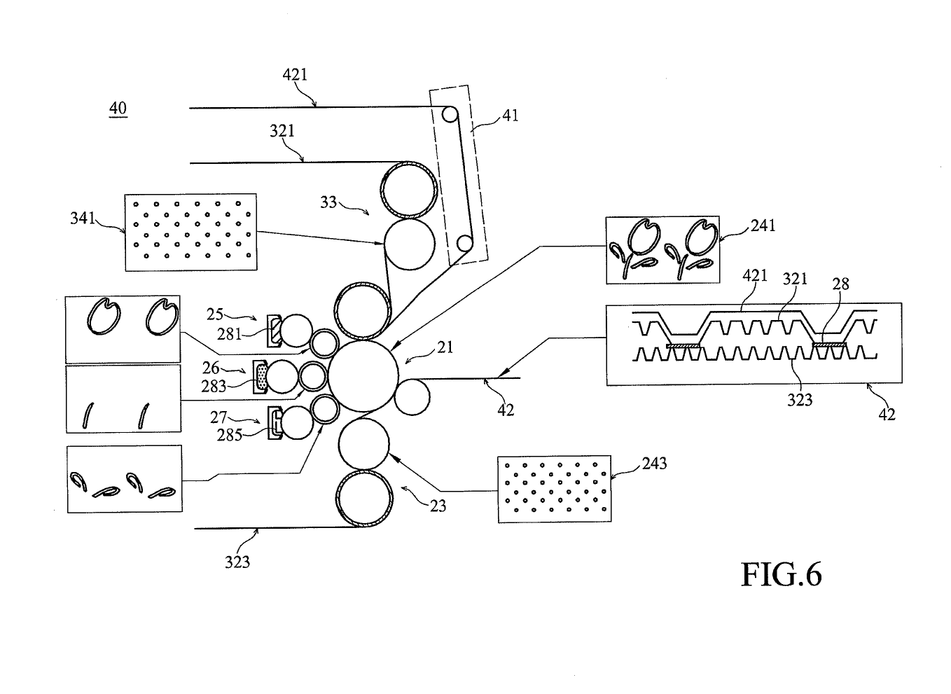

Referring to FIG. 6, a web product embossing apparatus 40 in accordance with a third embodiment of the present invention is shown. The web product embossing apparatus 40 comprises a first embossing wheel set 21, a second embossing wheel set 23, a third embossing wheel set 33, a transferring unit 41 and a plurality of glue applicators 25/26/27. The glue applicators 25/26/27 are arranged adjacent to the first embossing wheel set 21 and adapted for applying a respective glue to a first web product 321 at the first embossing wheel set 21. The transferring unit 41 is adapted for transferring a third web product 421 to the first embossing wheel set 21, and then the first web product 321, the second web product 323, and the third web product 421 are bonded together forming the desired finished web product 42.

According to this third embodiment, the first web product 321 is firstly transferred through the third embossing wheel set 33 where the third embossing wheel set 33 embosses at least a raised third embossed pattern 341 on the first web product 321, and then transferred to the first embossing wheel set 21. The transferring unit 41 is adapted for transferring a third web product 421 to the first embossing wheel set 21 for enabling the first web product 321 and the third web product 421 to be overlapped and then embossed by the first embossing wheel set 21 to form a raised first embossed pattern 241 on the overlapped web product of the first web product 321 and the third web product 421.

Thereafter, the glue applicators 25/26/27 are operated to apply different glues 281/283/285 to the first web product 321 at the first embossing wheel set 21 so that the raised first embossed pattern 241 of the first web product 321 can have different colors, and then the overlapped web product of the first web product 321 and the third web product 421 is bonded with the second web product 323 to form a finished web product 42.

According to the aforesaid third embodiment, the overlapped web product of the first web product 321 and the third web product 421 carries the raised first embossed pattern 241 (coarse pattern), and the glue applicators 25/26/27 can be operated to apply different glues 281/283/285 to different parts of the raised first embossed pattern 241 so that the raised first embossed pattern 241 can have different colors. Further, the first web product 321 also carries a raised third embossed pattern 341 that supports the raised first embossed pattern 241 of the third web product 421.

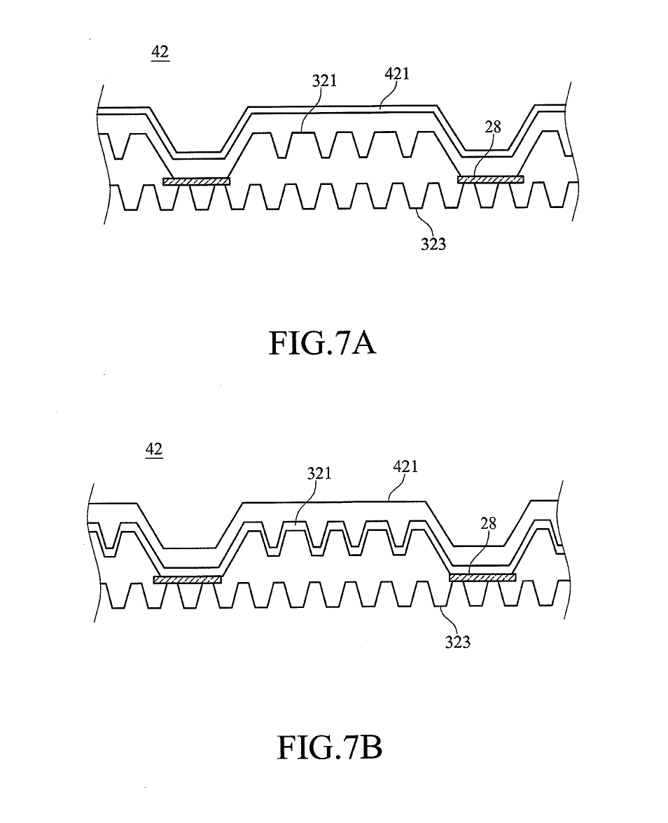

Further, in one example of this third embodiment, the first web product 321, the second web product 323 and the third web product 421 are a single-layer of paper processed to form a finished web product 42 as shown in FIG. 6. In another example of this third embodiment, the third web product 421 is a double-layer of paper; the first web product 321 and the second web product 323 are a single-layer of paper; the third web product 421, the first web product 321 and the second web product 323 are processed to form a finished web product 42 as shown in FIG. 7A. In still another example of this third embodiment, the first web product 321 is a double-layer of paper; the second web product 323 and the third web product 421 are single-layer of paper; the first web product 321 and the second web product 323 are processed to form a finished web product 42 as shown in FIG. 7B.

The finished web product 42 made according to this third embodiment is a web product having at least three layers where the first web product 321 is sandwiched between the second web product 323 and the third web product 421 so that the user using the finished web product 42 does not touch the first web product 321 directly. Thus, the first web product 321 can be prepared from a relatively inferior material to reduce the cost without affecting the product quality.

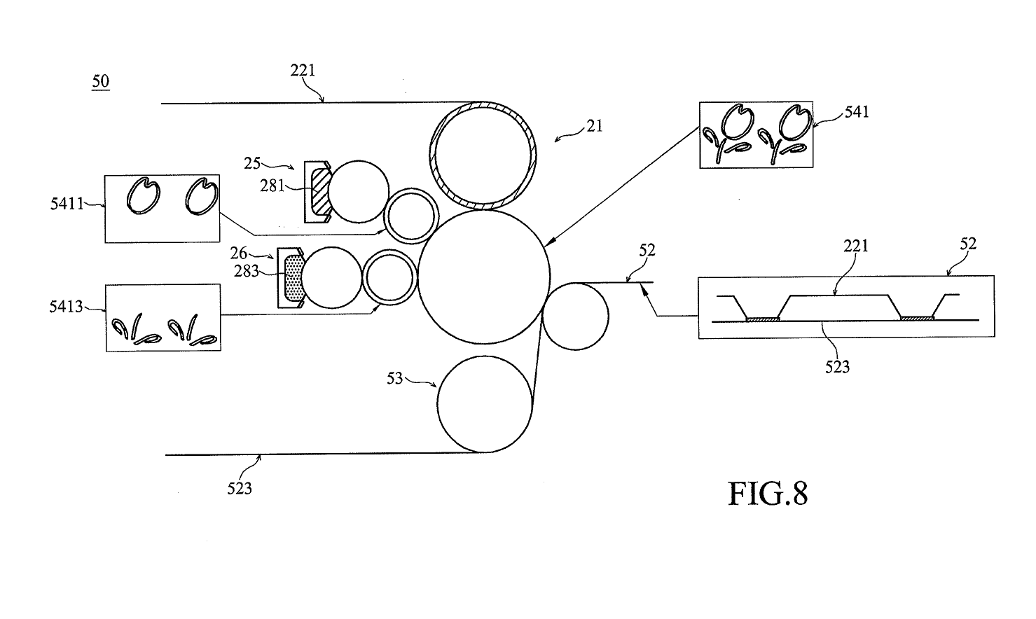

FIG. 8 shows a web product embossing apparatus 50 in accordance with a fourth embodiment of the present invention. In the aforesaid various embodiments of the present invention, the web product embossing apparatuses 20/30/40 commonly comprises a first embossing wheel set 21, a second embossing wheel set 23, and three glue applicators 25/26/27. In actual practice, the second embossing wheel set 23 can be omitted, and the number of the glue applicators can be 2 or 3. According to this fourth embodiment, the web product embossing apparatus 50 comprises a first embossing wheel set 21, a transferring wheel set 53, a first glue applicator 25 and a second glue applicator 26. The first glue applicator 25 and the second glue applicator 26 are arranged adjacent to the first embossing wheel set 21 and adapted for applying a respective glue to a first web product 221 at the first embossing wheel set 21. The first embossing wheel set 21 is adapted for transferring the first web product 221 and embossing at least a raised first embossed pattern 541 on the first web product 221. The transferring wheel set 53 is adapted for transferring a second web product 523 that is a plain web product without any raised embossed pattern.

According to this fourth embodiment, the raised first embossed pattern 541 on the first web product 221 is divided into a first pattern unit 5411 and a second pattern unit 5413. The first glue applicator 25 is adapted to apply a first glue 281 to the first pattern unit 5411. The second glue applicator 26 is adapted to apply a second glue 283 to the second pattern unit 5413. The first glue 281 and the second glue 283 contain different color pigments. Thus, the applied first glue 281 and second glue 283 can bond the first web product 221 and the second web product 523 to form a finished web product 52, and give different colors to the first pattern unit 5411 and the second pattern unit 5413. For example, the first pattern unit 5411 can be glued to have a pink color, and the second pattern unit 5413 can be glued to have a green color.

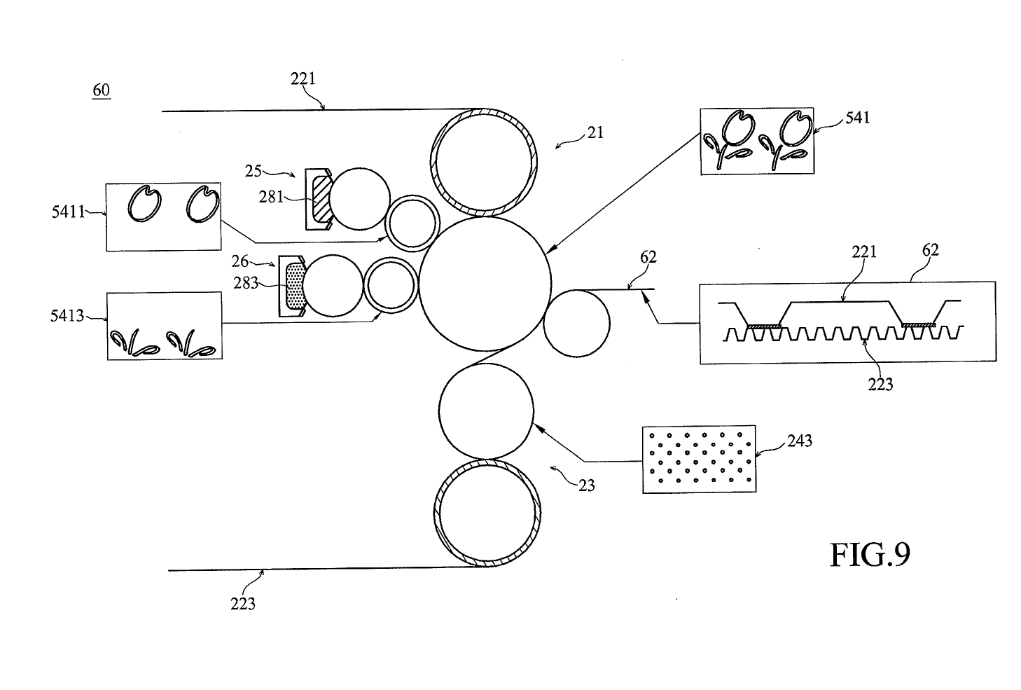

In actual practice, the transferring wheel set 53 and the second embossing wheel set 23 can be the same wheel set. As shown FIG. 9, a web product embossing apparatus 60 in accordance with a fifth embodiment of the present invention comprises a first embossing wheel set 21, a second embossing wheel set 23, a first glue applicators 25 and a second glue 26, wherein the first glue applicator 25 and the second glue applicator 26 are arranged adjacent to the first embossing wheel set 21 and adapted for applying a respective glue to a first web product 221 at the first embossing wheel set 21.

The first embossing wheel set 21 is adapted for transferring the first web product 221 and embossing at least a raised first embossed pattern 541 on the first web product 221. The raised first embossed pattern 541 on the first web product 221 is divided into a first pattern unit 5411 and a second pattern unit 5413. The first glue applicator 25 is adapted to apply a first glue 281 to the first pattern unit 5411. The second glue applicator 26 is adapted to apply a second glue 283 to the second pattern unit 5413. The second embossing wheel set 23 is adapted for transferring a second web product 223 and embossing at least a raised second embossed pattern 243 on the second web product 223, and then transferring the embossed second web product 223 to the first embossing wheel set 21 for enabling the first web product 221 and the second web product 223 to be bonded together to form a finished web product 62.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A web product embossing apparatus, comprising:
a first embossing wheel set, said first embossing wheel set comprising a first embossing wheel and a second embossing wheel, said second embossing wheel comprising a plurality of protrusions raised from the periphery thereof and adapted for embossing at least one raised first embossed pattern on a first web product, said raised first embossed pattern comprising a first pattern unit and a second pattern unit;
a transferring wheel set adapted for transferring a second web product to said first embossing wheel set;
a first glue applicator disposed adjacent to said first embossing wheel set and adapted for applying a first glue to said first pattern unit, said first glue containing a first color pigment; and
a second glue applicator disposed adjacent to said first embossing wheel set and adapted for applying a second glue to said second pattern unit, said second glue containing a second pigment, said second pigment having a different color relative to said first color pigment.

2. The web product embossing apparatus as claimed in claim 1, wherein said transferring wheel set is a second embossing wheel set adapted for embossing at least a raised second embossed pattern on said second web product and transferring said second web product to said first embossing wheel set.

3. The web product embossing apparatus as claimed in claim 2, wherein said first glue applicator comprises a first glue applicator wheel and a first glue reservoir, said first glue reservoir holding said first glue therein, said first glue applicator wheel comprising at least one glue applicator portion raised from the periphery thereof; said second glue applicator comprises a second glue applicator wheel and a second glue reservoir, said second glue reservoir holding said second glue therein, said second glue applicator wheel comprising at least one glue applicator portion raised from the periphery thereof.

4. The web product embossing apparatus as claimed in claim 2, further comprising a third glue applicator disposed adjacent to said first embossing wheel set, wherein said raised first embossed pattern further comprises at least one third embossed pattern unit; said third glue applicator is adapted to apply a third glue to said at least one third pattern unit, said third glue containing a third color pigment having a color different from the colors of said first color pigment and said second color pigment.

5. The web product embossing apparatus as claimed in claim 2, further comprising a third embossing wheel set adapted for embossing at least a raised third embossed pattern on said first web product and then transferring said first web product to said first embossing wheel set.

6. The web product embossing apparatus as claimed in claim 2, wherein said first web product is a single-layer or double-layer of paper; said second web product is a single-layer or double-layer of paper.

7. The web product embossing apparatus as claimed in claim 1, wherein the protrusions of said second embossing wheel are configured subject to the shape of said raised first embossed pattern.

8. A web product embossing apparatus, comprising:
a first embossing wheel set, said first embossing wheel set comprising a first embossing wheel and a second embossing wheel, said second embossing wheel comprising a plurality of protrusions raised from the periphery thereof and adapted for embossing at least one raised first embossed pattern on a first web product, each said raised first embossed pattern comprising a plurality of pattern units;
a transferring wheel set adapted for transferring a second web product to said first embossing wheel set; and
a plurality of glue applicators disposed adjacent to said first embossing wheel set and adapted for applying different glues having different colors to different pattern units of each said raised first embossed pattern.

9. The web product embossing apparatus as claimed in claim 8, wherein said glue applicators each comprise a glue applicator wheel and a glue reservoir, the glue reservoir of each said glue applicator holding a respective glue containing a respective color pigment, said glue applicator wheel being kept in contact with said first web product.

10. The web product embossing apparatus as claimed in claim 8, wherein said transferring wheel set is a second embossing wheel set adapted for embossing at least one raised second embossed pattern on said second web product and transferring said second web product to said first embossing wheel set.

11. The web product embossing apparatus as claimed in claim 8, wherein the protrusions of said second embossing wheel are configured subject to the shape of said raised first embossed pattern.
